(19) United States
(12) Patent Application Publication
(10) Pub. No.: US 2014/0186174 A1
(43) Pub. Date: Jul. 3, 2014

(54) TURBOCHARGER ASSEMBLY

(71) Applicant: SPEED OF AIR, INC., Reno, NV (US)

(72) Inventor: Joey A. Malfa, Reno, NV (US)

(73) Assignee: SPEED OF AIR, INC., Reno, NV (US)

(21) Appl. No.: 14/133,454

(22) Filed: Dec. 18, 2013

Related U.S. Application Data
(60) Provisional application No. 61/746,529, filed on Dec. 27, 2012.

(51) Int. Cl. F15D 1/00; F01D 5/14; F01D 25/24

(52) U.S. Cl. CPC F15D 1/005; F01D 25/24; F01D 5/14
USPC 415/220; 416/235

(57) ABSTRACT

A turbocharger assembly including a turbine housing defining an exhaust inlet opening and an exhaust outlet opening and a turbine wheel housed in the turbine housing. The turbocharger assembly also includes a compressor housing defining an air inlet opening and an air outlet opening and a compressor wheel housed in the compressor housing. The turbocharger assembly also includes a shaft coupling the turbine wheel to the compressor wheel. The turbine housing, the turbine wheel, the compressor housing, and/or the compressor wheel includes a surface having a series of protrusions or depressions configured to increase the efficiency of the turbocharger assembly.

### CROSS-REFERENCE TO RELATED APPLICATION

This application claims the benefit of and priority to U.S. Provisional Application No. 61/746,529, filed Dec. 27, 2012, the entire content of which is incorporated herein by reference.

### FIELD

The present invention relates generally to turbocharger assemblies and, more particularly, to turbocharger assemblies with airflow-increasing features.

### BACKGROUND

Performance automobiles commonly incorporate a turbocharger to increase the power output of the automobile's engine by compressing airflow through the engine. Turbochargers conventionally include a turbine wheel housed in a turbine housing and a compressor wheel housed in a compressor housing. The turbine wheel is rotatably coupled to the compressor wheel by a shaft. The turbine housing is coupled to the automobile's exhaust manifold such that exhaust from the engine is configured to flow through the turbine housing and rotate the turbine wheel. The compressor housing is coupled to an intake manifold for supplying air to the combustion chambers of the engine. Accordingly, when the exhaust passes through the compressor housing and spins the compressor wheel, the shaft drives the compressor wheel and thereby forces air into the intake manifold and the combustion chambers. The increased volume of air forced into the combustion chambers by the compressor wheel allows a greater amount of fuel to be combusted, which increases the power output of the engine.

However, the performance of conventional turbochargers is limited by a variety of factors, including the size of air inlets and air outlets of the compressor housing and the turbine housing, heat transfer between the turbine housing and the compressor housing, which reduces the density of the airflow through the compressor housing, and the formation of low pressure turbulent vortices in the air flowing through both the compressor housing and the turbine housing.

### SUMMARY

The present disclosure is directed to various embodiments of a turbocharger assembly configured to increase airflow to an intake manifold of an internal combustion engine. In one embodiment, the turbocharger assembly includes a turbine housing defining an exhaust inlet opening and an exhaust outlet opening, a turbine wheel housed in the turbine housing, a compressor housing defining an air inlet opening and an air outlet opening, a compressor wheel housed in the compressor housing, and a shaft coupling the turbine wheel to the compressor wheel. The turbine housing, the turbine wheel, the compressor housing, and/or the compressor wheel includes a surface having a series of protrusions or depressions. The protrusions or depressions may have any suitable shape, such as semi-spherical, prismatic, pyramidal, or conical. The protrusions or depressions may have any suitable size, such as a width from approximately 1.5 mm to approximately 9.5 mm and a height or depth from approximately 0.5 mm to approximately 6.5 mm.

The turbocharger assembly may also include a thermal barrier coating on the turbine housing, the turbine wheel, the compressor housing, and/or the compressor wheel. The thermal barrier coating may be made of any suitable material, such as an aluminum-filled ceramic.

The turbine wheel may include a series of blades having rounded edges. The compressor wheel may include a series of blades each having a leading edge and a trailing edge, and a series of protrusions or depressions proximate to the leading edges of the blades.

The turbocharger assembly may also include a series of axial or helical grooves circumferentially disposed around an inner surface of the air inlet opening, the air outlet opening, the exhaust inlet opening, and/or the exhaust outlet opening. The helical grooves may be spaced apart from each other by any suitable distance, such as from approximately 2.5 mm to approximately 12 mm. The helical grooves may have any suitable angle, such as from approximately 15 degrees to approximately 60 degrees. A series of protrusions or depressions may be provided within the axial or helical grooves.

The air inlet opening and/or the air outlet opening of the compressor housing may taper between a wider outer end and a narrower inner end. The exhaust inlet opening and/or the exhaust outlet opening of the exhaust turbine housing may also taper between a wider outer end and a narrower inner end.

The present disclosure is also directed to a compressor assembly. In one embodiment, the compressor assembly includes compressor housing defining an air inlet opening and an air outlet opening, a compressor wheel housed in the turbine, and a shaft coupled to the compressor wheel. The compressor housing and/or the compressor wheel includes a surface having a series of protrusions or depressions. The protrusions or depressions may have any suitable shape, such as semi-spherical, prismatic, pyramidal, or conical. The compressor assembly may also include a series of grooves around an inner surface of the air inlet opening and/or the air outlet opening.

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is an exploded perspective view of a turbocharger assembly for an internal combustion engine according to one embodiment of the present disclosure;

FIG. 2 is a perspective view of a compressor housing according to one embodiment of the present disclosure;

FIGS. 3A and 3B are cross-sectional views of an air inlet and an air outlet of the compressor housing of FIG. 2 according to one embodiment of the present disclosure;

FIG. 4 is a perspective view of an exhaust turbine housing according to one embodiment of the present disclosure;

FIGS. 5A and 5B are cross-sectional views of an exhaust inlet and exhaust outlet of the exhaust turbine housing of FIG. 4 according to one embodiment of the present disclosure;

FIG. 6 is a perspective view of a compressor wheel according to one embodiment of the present disclosure; and

FIG. 7 is a perspective view of an exhaust turbine wheel according to one embodiment of the present disclosure.

### DETAILED DESCRIPTION

The present disclosure is directed to various embodiments of a turbocharger assembly configured to increase airflow to an intake manifold of an internal combustion engine and thereby increase the output power of the engine. In one or more embodiments, one or more components of the turbocharger assembly may include a thermal barrier coating configured to reduce heat transfer between the coated component and the airflow through the turbocharger assembly. In one or more embodiments, air inlets and outlets of a compressor housing and a turbine housing of the turbocharger assembly may be configured to increase the volumetric airflow through the compressor and turbine housings. Additionally, in one or more embodiments, one or more components of the turbocharger assembly may include surface texturing or patterning configured to mitigate the formation of turbulent vortices and concomitant low pressure areas that would otherwise decrease the pressure, volume, and speed of the airflow through the turbocharger assembly and into combustion chambers of the internal combustion engine. The various features of the turbocharger assembly described below are configured to increase the performance of the turbocharger assembly and the internal combustion engine onto which the turbocharger assembly is installed. The performance gains may include faster turbocharger response times, improved throttle response, increased turbocharger efficiency, reduced fuel consumption, increased power output from the engine, increased fuel mileage, and reduced exhaust emissions.

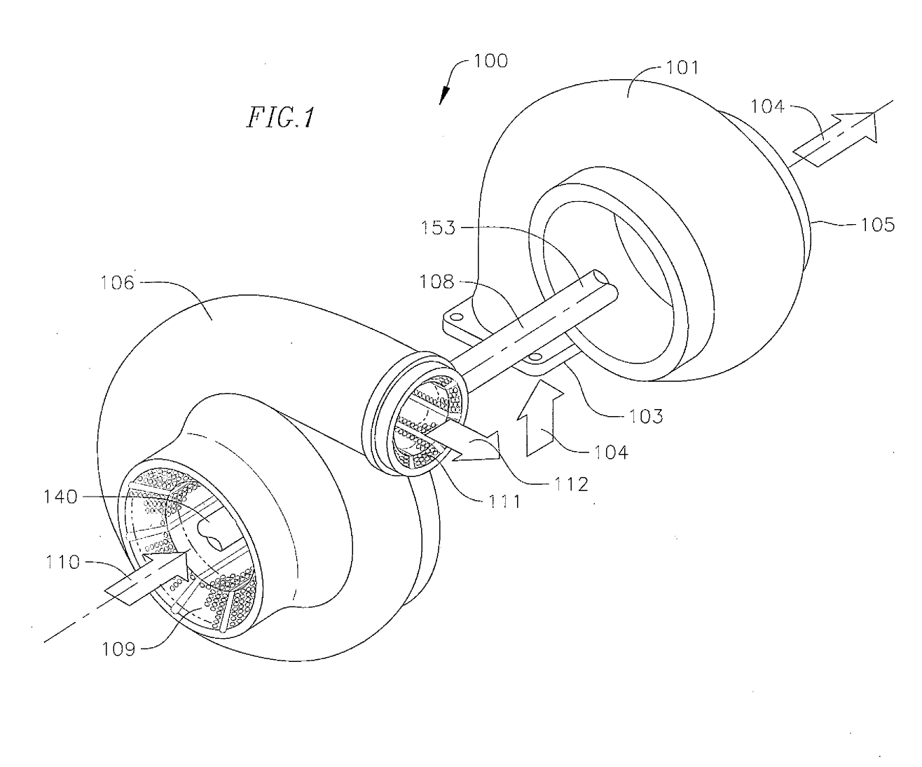

With reference now to the embodiment illustrated in FIG. 1, a turbocharger assembly 100 includes a turbine housing 101 and a turbine wheel 102 housed in a chamber defined by the turbine housing 101. The turbine housing 101 is configured to be coupled to an exhaust manifold of an internal combustion engine. The turbine housing 101 includes an exhaust air inlet 103 configured to receive exhaust airflow (arrow 104) from the internal combustion engine. The exhaust airflow 104 is configured to enter the turbine housing 101 through the exhaust air inlet 103, rotate the turbine wheel 102 housed in the turbine housing 101, and exit the turbine housing 101 through an exhaust air outlet 105 in the turbine housing 101.

With continued reference to the embodiment illustrated in FIG. 1, the turbocharger assembly 100 also includes a compressor housing 106 and a compressor wheel 107 housed in a chamber defined by the compressor housing 106. The compressor wheel 107 is coupled to the turbine wheel 102 by a shaft 108 such that the compressor wheel 107 is configured to rotate synchronously with the turbine wheel 102. The compressor housing 106 includes an air inlet opening 109 for receiving ambient airflow (arrow 110) and an air outlet opening 111 for directing compressed airflow (arrow 112) to an intake manifold and a series of combustion chambers of the internal combustion engine. The ambient airflow 110 entering the compressor housing 106 through the air inlet opening 109 is accelerated by the rotating compressor wheel 107 and exits the air outlet opening 111 as compressed airflow 112 having an elevated pressure (i.e., the compressed airflow 112 exiting the compressor housing 106 has a higher pressure than the ambient airflow 110 entering the compressor housing 106). The elevated pressure of the compressed airflow 112 exiting through the air outlet opening 111 and entering the intake manifold permits a greater amount of fuel to be injected into the combustion chambers, which increases the power output of the engine.

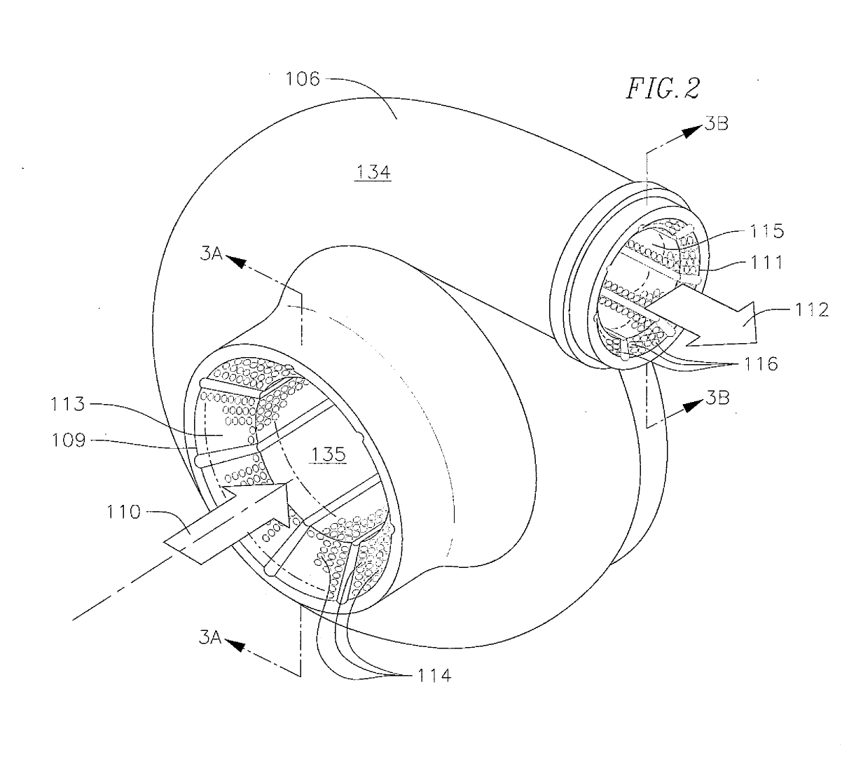

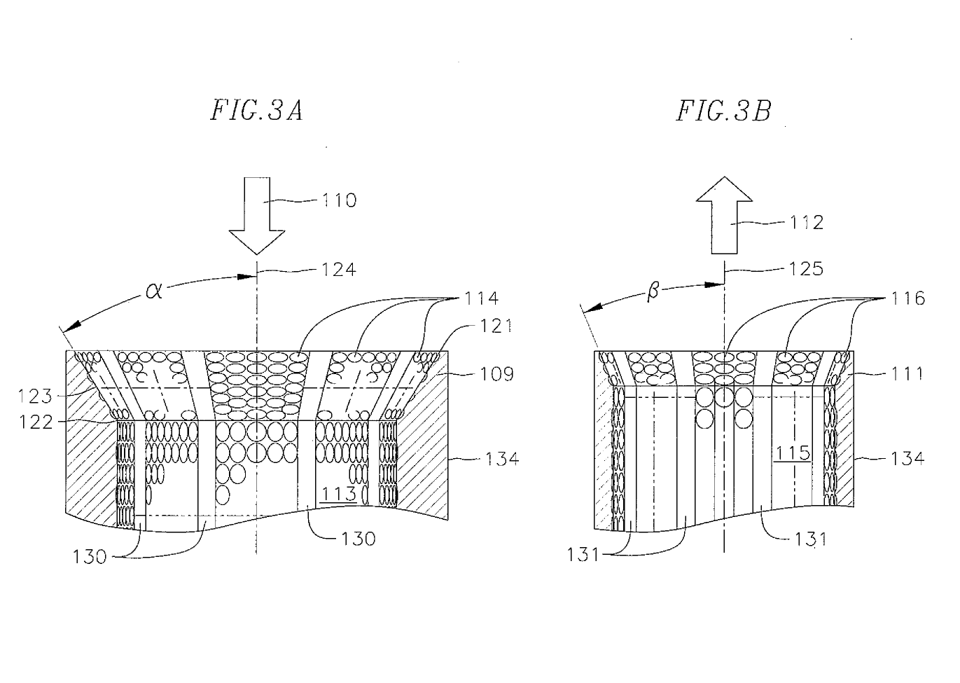

With reference now to the embodiment illustrated in FIGS. 2 and 3A, an inner surface 113 of the air inlet opening 109 includes a plurality of depressions 114 (e.g., dimples). When the ambient airflow 110 passes over the dimples 114 in the air inlet opening 109, the dimples 114 induce the formation of a turbulent boundary layer covering the inner surface 113 of the air inlet opening 109 (i.e., the dimples act as “turbulators”). The turbulent boundary layer is energized and tends to prevent or delay boundary layer airflow separation from the inner surface 113 of the inlet opening 109. Without the presence of the dimples 114, the boundary layer would tend to separate from the inner surface 113 of the inlet opening 109, resulting in the formation of low pressure vortices that reduce the velocity, pressure, and volume of the airflow 110 into the compressor housing 106 through the air inlet opening 109 (i.e., the dimples 114 create an energized turbulent boundary layer that tends to delay the onset of airflow separation and the formation of low pressure eddies in the airflow 110). Accordingly, the dimples 114 are configured to increase the velocity, pressure, and volume of the airflow 110 through the air inlet opening 109 of the compressor housing 106, which results in the increased velocity, pressure, and volume of the compressed airflow 112 out from the air outlet opening 111 of the compressor housing 106 and into the combustion chambers of the internal combustion engine. In one or more alternate embodiments, the inner surface 113 of the air inlet opening 109 may include a plurality of protrusions configured to induce the formation of an energized turbulent boundary layer. In further embodiments, the inner surface 113 of the air inlet opening 109 may include a combination of a plurality of depressions and a plurality of protrusions.

Additionally, in the embodiment illustrated in FIGS. 2 and 3B, an inner surface 115 of the air outlet opening 111 includes a plurality of depressions 116 (e.g., dimples). In substantially the same manner described above, the dimples 116 in the air outlet opening 111 are configured to create an energized turbulent boundary layer that tends to prevent or delay boundary layer airflow separation from the inner surface 115 of the air outlet opening 111 and the concomitant formation of low pressure vortices that would reduce the velocity, pressure, and volume of the compressed airflow 112 out from the air outlet opening 111 of the compressor housing 106. In one or more alternate embodiments, the inner surface 115 of the air outlet opening 111 may include a plurality of protrusions or a combination of a plurality of depressions and a plurality of protrusions.

The depressions and/or protrusions 114, 116 in the air inlet and outlet openings 109, 111, respectively, of the compressor housing 106 may have any desired shape, such as, for instance, spherical, prismatic (e.g., square or diamond prismatic), pyramidal, conical, or any portions or combinations of such shapes. Additionally, the depressions and/or protrusions 114, 116 may have any desired size. For instance, in one embodiment, the depressions and/or protrusions 114, 116 may have a width or diameter from approximately 1.5 mm to approximately 9.5 mm. In another embodiment, the width or diameter of the depressions and/or protrusions 114, 116 may range from approximately 2.5 mm to approximately 6.5 mm. The depressions and/or protrusions 114, 116 may also have any desired depth or height. In one embodiment, the depth or height of the depressions and/or protrusions 114, 116 may range from approximately 0.5 mm to approximately 6.5 mm. In another embodiment, the depth or height of the depressions and/or protrusions 114, 116 may range from approximately 2.5 mm to approximately 4.0 mm. Although in one embodiment each of the protrusions or depressions 114, 116 may have the same size and shape (e.g., the protrusions or depressions 114, 116 may be uniform), in one or more alternate embodiments, the size and/or shape of the protrusions and/or depressions 114, 116 may differ or vary across the inner surfaces 113, 115 of the inlet and outlet openings 109, 111, respectively.

With continued reference to the embodiment illustrated in FIGS. 2 and 3A, the air inlet opening 109 of the compressor housing 106 tapers between a wider outer end 121 and a narrower inner end 122. In one embodiment, the inlet opening 109 includes a chamfer or a fillet 123 extending between the wider and narrower ends 121, 122. The tapered air inlet opening 109 is configured to increase the maximum potential volume of ambient airflow 110 through the compressor housing 106 and thereby increase the efficiency of the turbocharger assembly 100. The air inlet opening 109 may taper at any suitable angle α relative to an imaginary axis 124 of the air inlet opening 109, such as, for instance, from approximately 15 degrees to approximately 60 degrees. In the embodiment illustrated in FIG. 3B, the compressor housing 106 may include a tapered air outlet opening 111 that is the same or similar to the tapered air inlet opening 109. In an alternate embodiment, the tapered air outlet opening 111 of the compressor housing 106 may have a different configuration (e.g., a different taper angle) than the tapered air inlet opening 109. The air outlet opening 111 may taper at any suitable angle β relative to an imaginary axis 125 of the air outlet opening 111, such as, for instance, from approximately 15 degrees to approximately 60 degrees. The tapered air outlet 111 is configured to decrease the back pressure at the air outlet 111 and thereby increase the speed, volume, and pressure of the airflow 110, 112 through the compressor housing 106 (e.g., the tapered air outlet 111 acts as a diffuser increasing the velocity of the airflow 110, 112 through the compressor housing 106). Accordingly, the tapered air outlet opening 111 is configured to increase the efficiency of the turbocharger assembly 100 by increasing the speed, volume, and pressure of the airflow 112 to the intake manifold of the internal combustion engine.

Still referring to the embodiment illustrated in FIGS. 2 and 3A, the compressor housing 106 includes a plurality of grooves or slots 130 circumferentially disposed around the inner surface 113 of the air inlet opening 109. The grooves 130 are configured to increase the volume of airflow 110 through the compressor housing 106 by increasing the effective cross-sectional area of the inlet opening 109. The grooves 130 may have any suitable cross-sectional shape, such as, for instance, square, rectangular, triangular (e.g., V-shaped), or semi-circular (e.g., U-shaped). Additionally, the air inlet opening 109 of the compressor housing 106 may have any suitable number of grooves 130, such as, for instance, from four to twenty grooves. The grooves 130 may have any suitable depth, such as, for instance, from approximately 2.5 mm to approximately 7.5 mm. In one embodiment, the spacing between adjacent grooves 130 (i.e., the pitch of the grooves 130) may range from approximately 2.5 mm to approximately 12 mm. In the illustrated embodiment, the depressions and/or protrusions 114 are not provided along the grooves 130, although in one or more alternate embodiments, one or more depressions and/or protrusions 114 may be provided along the grooves 130. Additionally, in the illustrated embodiment, the grooves 130 extend axially along the air inlet opening 109 (i.e., the grooves 130 are parallel with the axis 124 of the air inlet opening 109).

In one or more alternate embodiments, the grooves 130 may be helically disposed around the inner surface 113 of the air inlet opening 109 rather than axially disposed along the air inlet opening 109. The helical grooves 130 are configured to create a vortex of airflow to accelerate the airflow 110 into the compressor housing 106 and thereby draw increased airflow 110 through the compressor housing 106 and into the combustion chambers of the engine. The helical grooves 130 may be oriented at any suitable angle, such as, for instance, from approximately 15 degrees to approximately 50 degrees relative to the axis 124 of the inlet opening 109. In general, helical grooves oriented at larger angles are configured to produce increased turbocharger efficiency at lower internal combustion engine speeds and helical grooves oriented at relatively smaller angles are configured to produce increased turbocharger efficiency at higher internal combustion engine speeds. Accordingly, the angle of the helical grooves may be selected based upon the intended operating conditions of the internal combustion engine and the desired performance characteristics of the turbocharger assembly 100.

Additionally, in the embodiment illustrated in FIG. 3B, the inner surface 115 of the air outlet opening 111 of the compressor housing 106 may include a plurality of grooves 131 that are the same or similar to the grooves 130 in the air inlet opening 109. In an alternate embodiment, the grooves 131 in the outlet opening 111 may have a different configuration (e.g., a different angle and/or cross-sectional shape) than the grooves 130 in the air inlet opening 109. The grooves 131 may be axially or helically disposed around the inner surface 115 of the air outlet opening 111. The grooves 131 in the air outlet opening 111 are configured to increase the volume of compressed airflow 112 out from the compressor housing 106 and into the intake manifold of the internal combustion engine by increasing the cross-sectional area of the air outlet opening 111. Accordingly, the grooves 130, 131 in the air inlet 109 and/or air outlet 111, respectively, of the compressor housing 106 are configured to increase the efficiency of the turbocharger assembly 100 and the power output of the internal combustion engine.

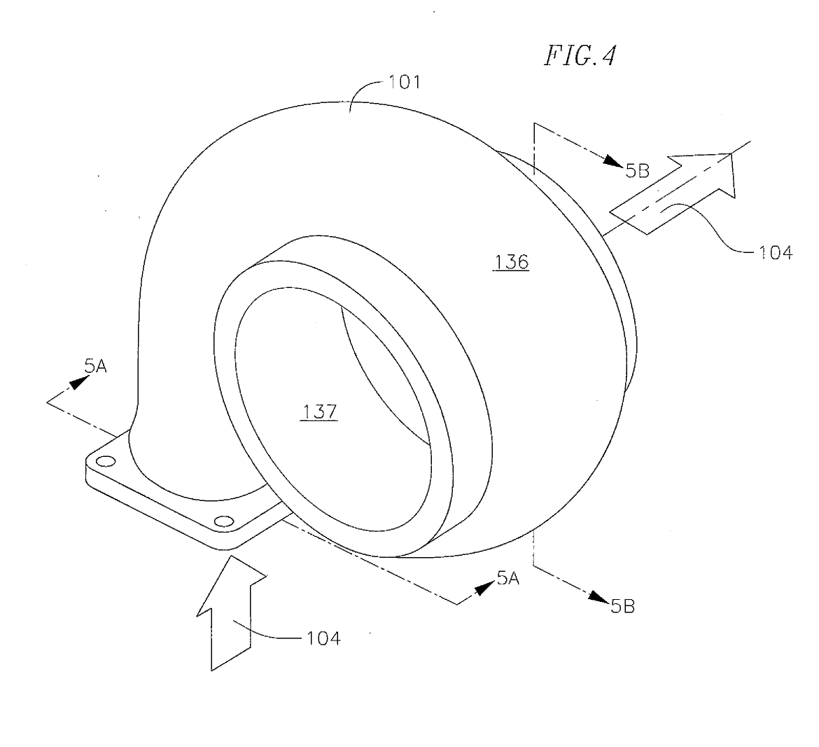

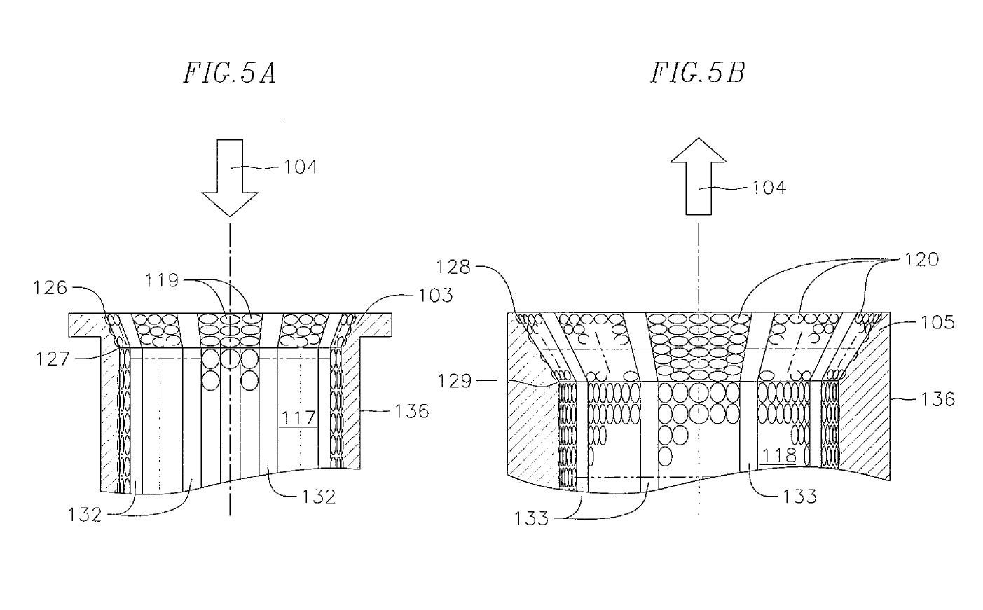

With reference now to the embodiment illustrated in FIGS. 4, 5A, and 5B, inner surfaces 117, 118 of the exhaust air inlet 103 and exhaust air outlet 105, respectively, of the exhaust turbine housing 101 may include a plurality of protrusions and/or depressions (e.g., dimples) 119, 120, respectively. The protrusions and/or depressions 119, 120 may have any suitable shape, such as, for instance, spherical, prismatic (e.g., square or diamond prismatic), pyramidal, conical, or any portions or combinations of such shapes, and any desired size, such as, for instance, a width or diameter from approximately 1.5 mm to approximately 9.5 mm and a depth or height from approximately 0.5 mm to approximately 6.5 mm. The protrusions and/or depressions 119, 120 in the exhaust air inlet 103 and the exhaust air outlet 105, respectively, may be the same or similar to the protrusions and/or depressions 114, 116 in the air inlet opening 109 and the air outlet opening 111, respectively, of the compressor housing 106. In an alternate embodiment, the protrusions and/or depressions 119, 120 in the exhaust air inlet 103 and/or exhaust air outlet 105 of the exhaust turbine housing 101 may have a different configuration (e.g., a different size or shape) than the protrusions and/or depressions 114, 116 in the air inlet opening 109 and air outlet opening 111, respectively, of the compressor housing 106.

With continued reference to the embodiment illustrated in FIGS. 4 and 5A, the exhaust inlet opening 103 of the exhaust turbine housing 101 may taper between a wider outer end 126 and a narrower inner end 127 to increase the maximum potential exhaust airflow 104 through the turbine housing 101 and thereby increase the efficiency of the turbocharger assembly 100. As illustrated in FIG. 5B, the exhaust outlet 105 of the exhaust turbine housing 101 may similarly taper between a wider outer end 128 and a narrower inner end 129 to reduce the back pressure at the exhaust outlet 105 and thereby increase the velocity of the exhaust airflow 104 through the exhaust turbine housing 101 (e.g., the tapered exhaust outlet 105 acts as a diffuser increasing the velocity of the exhaust airflow 104 through the exhaust turbine housing 101). The exhaust inlet 103 and the exhaust outlet 105 may taper at any suitable angles, such as, for instance, from approximately 15 degrees to approximately 60 degrees. Although in one embodiment the configuration of the exhaust inlet 103 may be the same or similar to the configuration of the exhaust outlet 105, in one or more alternate embodiments, the configuration of the exhaust inlet 103 may differ from the configuration of the exhaust outlet 105 (e.g., the exhaust inlet 103 may taper at a different angle than the exhaust outlet 105).

Still referring to the embodiment illustrated in FIGS. 4, 5A, and 5B, the inner surfaces 117, 118 of the exhaust inlet 103 and the exhaust outlet 105, respectively, of the exhaust turbine housing 101 may include a plurality of grooves 132, 133, respectively. The grooves 132, 133 may be axially or helically disposed around the inner surfaces 117, 118 of the exhaust inlet 103 and the exhaust outlet 105, respectively. The grooves 132, 133 may have any suitable cross-sectional shape, such as, for instance, square, rectangular, triangular (e.g., V-shaped), or semi-circular (e.g., U-shaped), and any suitable depth, such as, for instance, from approximately 2.5 mm to approximately 7.5 mm. The exhaust inlet 103 and the exhaust outlet 105 of the exhaust turbine housing 101 may each have any suitable number of grooves 132, 133, such as, for instance, from four to twenty grooves. Additionally, in one embodiment, the spacing between adjacent grooves 132, 133, respectively, may range from approximately 2.5 mm to approximately 12 mm. In one embodiment, the grooves 132, 133 in the exhaust inlet 103 and the exhaust outlet 105 may be the same or similar to the grooves 130, 131 in the air inlet 109 and the air outlet 111 of the compressor housing 106. In an alternate embodiment, the grooves 132, 133 in the exhaust inlet 103 and/or the exhaust outlet 105 may have a different configuration (e.g., a different shape, size, or pitch) than the grooves 130, 131 in the air inlet 109 and/or air outlet 111 of the compressor housing 106. Additionally, in one embodiment, the grooves 132 in the exhaust inlet 103 may have a different configuration than the grooves 133 in the exhaust outlet 105.

With reference again to the embodiment illustrated in FIGS. 2, 3A, and 3B, outer surfaces 134 and/or inner surfaces 135 of the compressor housing 106 may be coated with a thermal barrier coating. The thermal barrier coatings are configured to prevent heat transfer between the exhaust turbine housing 101 and the compressor housing 106. Reducing heat transfer between the exhaust turbine housing 101 and the compressor housing 106 aids in maintaining a lower temperature of the intake airflow 110 flowing through the compressor housing 106. The lower intake airflow temperature increases the density of the intake airflow 110, which results in increased efficiency of the turbocharger assembly 100 and increased power output from the internal combustion engine.

Similarly, in the embodiment illustrated in FIGS. 4, 5A, and 5B, thermal barrier coatings may be applied to outer and/or inner surfaces 136, 137, respectively, of the exhaust turbine housing 101 to aid in reducing heat transfer to the compressor housing 106 and the intake airflow 110 flowing through the compressor housing 106. The thermal barrier coatings on the exhaust turbine housing 101 are configured to contain the heat from the exhaust airflow 104 within the exhaust turbine housing 101. To further reduce heat transfer between the exhaust turbine housing 101 and the compressor housing 106, a central bearing housing, which supports the shaft 108 and extends between the exhaust turbine housing 101 and the compressor housing 106, may be coated with a thermal barrier coating. The thermal barrier coatings may be made out of any suitable material, such as, for instance, an aluminum-filled ceramic coating. In one embodiment, the thermal barrier coatings on the central bearing housing and the outer surfaces 136 of the turbine housing 101 may be CBX or CBC-2, offered by Tech Line Coatings, Inc., or equivalents thereof. In one embodiment, the thermal barrier coating on the inner surfaces 137 of the turbine housing 101 may be Tech Line's TLHB Hi Heat Coating or equivalents thereof.

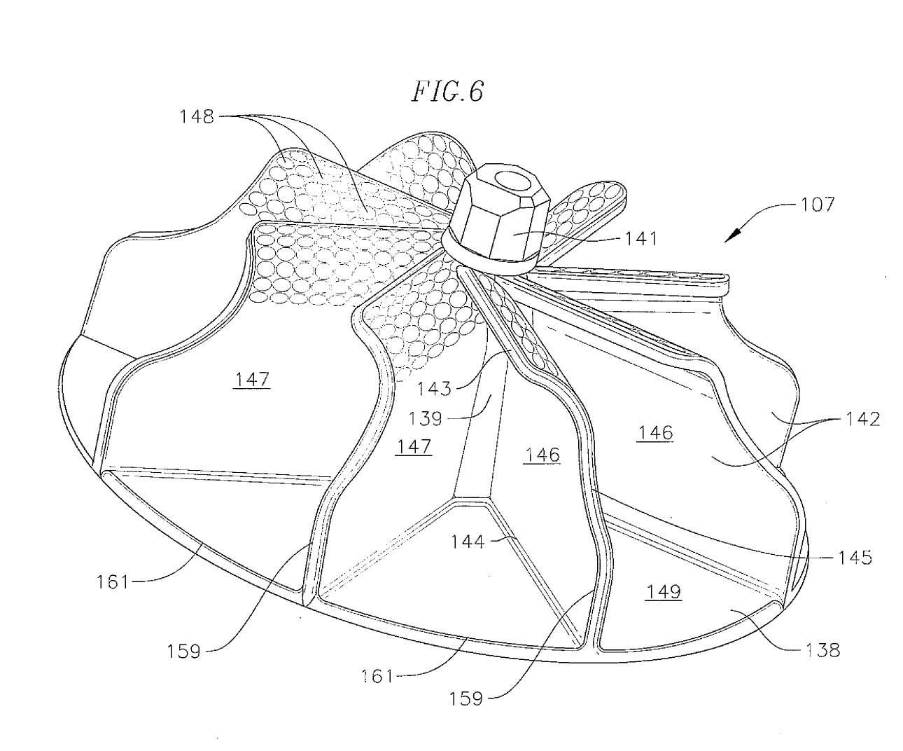

With reference now to the embodiment illustrated in FIG. 6, the compressor wheel 107 includes a base 138 and a cylindrical hub 139 projecting outward from the base 138. The hub 139 is configured to receive one end 140 of the shaft 108 (see FIG. 1) coupling the compressor wheel 107 to the turbine wheel 102. The compressor wheel 107 also includes a nut 141 for securing the compressor wheel 107 to the end 140 of the shaft 108. The compressor wheel 107 further includes a plurality of blades or vanes 142 radially disposed around the hub 139 and the base 138. Although the compressor wheel 107 in the illustrated embodiment includes eight blades 142, in one or more alternate embodiments, the compressor wheel 107 may include any other suitable number of blades 142, such as, for instance, from four to twenty blades. In the illustrated embodiment, each blade 142 includes a curved leading edge 143 and a trailing edge 144 coupled to the base 138. Each of the blades 142 also includes a contoured outer edge 145 such that the leading edge 143 of each blade 142 is narrower than the trailing edge 144. Each blade 142 also includes a front surface 146 and a rear surface 147.

With continued reference to the embodiment illustrated in FIG. 6, each blade 142 of the compressor wheel 107 also includes a plurality of depressions (e.g., dimples) and/or protrusions 148. In the illustrated embodiment, the depressions and/or protrusions 148 are located on the rear surfaces 147 of the blades 142 proximate to the leading edges 143. In one or more alternate embodiments, the depressions and/or protrusions 148 may be provided along the entire rear surfaces 147 of the blades 142 or at any other suitable locations, such as, for instance, on the front surfaces 146 of the blades 142 or on an outer surface 149 of the base 138. The depressions and/or protrusions 148 are configured to induce energized turbulent boundary layers that tend to prevent or delay airflow separation from the surfaces 146, 147 of the blades 142 and the concomitant formation of low-pressure vortices. Accordingly, the depressions and/or protrusions 148 are configured to reduce the aerodynamic drag on the blades 142 of the compressor wheel 107. The reduced drag on the blades 142 increases the rotational speed of the compressor wheel 107, which increases the volume of airflow 110 through the compressor housing 106 and into the intake manifold of the internal combustion engine. The depressions and/or protrusions 148 on the blades 142 of the compressor wheel 107 may have any desired shape, such as, for instance, spherical, prismatic (e.g., square or diamond prismatic), pyramidal, conical, or any portions or combinations of such shapes. Additionally, the depressions and/or protrusions 148 may have any desired size, such as, for instance, a width or diameter from approximately 1.5 mm to approximately 9.5 mm and a depth or height from approximately 0.5 mm to approximately 6.5 mm.

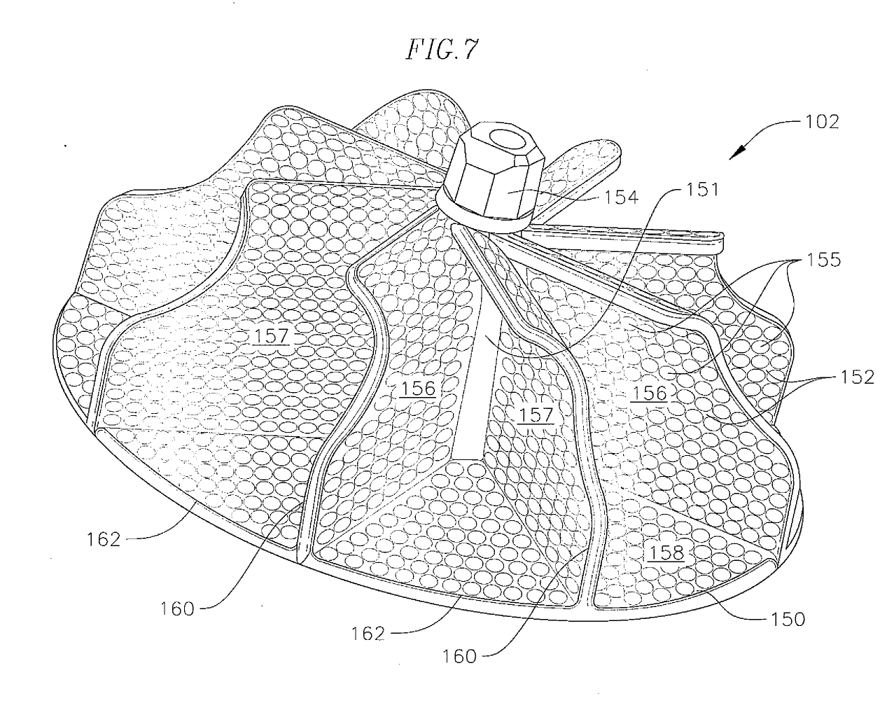

With reference now to the embodiment illustrated in FIG. 7, the exhaust turbine wheel 102 includes a base 150, a cylindrical hub 151 projecting outward from the base 150, and a plurality of blades or vanes 152 radially disposed around the hub 151 and the base 150. The cylindrical hub 151 is configured to receive an end 153 of the shaft 108 (see FIG. 1) coupling the turbine wheel 102 to the compressor wheel 107. The turbocharger assembly 100 also includes a nut 154 for securing the turbine wheel 102 to the end 153 of the shaft 108. In one embodiment, the exhaust turbine wheel 102 may have the same or substantially similar configuration as the compressor wheel 107. In one or more alternate embodiments, the configuration of the turbine wheel 102 may differ from the configuration of the compressor wheel 107. For instance, in one embodiment, the number of blades 152 on the turbine wheel 102 may differ from the number of blades 142 on the compressor wheel 107. Additionally, in one embodiment, the shape of the blades 152 on the turbine wheel 102 may differ from the shape of the blades 142 on the compressor wheel 107, In the illustrated embodiment, the turbine wheel 102 includes a plurality of depressions and/or protrusions 155 on front and rear surfaces 156, 157, respectively, of the blades 152 and on an outer surface 158 of the base 150. In one or more alternate embodiments, the depressions and/or protrusions 155 may be provided at any other suitable locations on the turbine wheel 102, such as, for instance, on only the blades 152 or portions thereof. The depressions and/or protrusions 155 are configured to induce turbulent boundary layers that eliminate or reduce the formation of low pressure vortices and thereby reduce the aerodynamic drag on the blades 152 of the turbine wheel 102. The reduced drag on the blades 152 increases the rotational speed of the turbine wheel 102, which in turn increases the rotational speed of the compressor wheel 107 and the volume and speed of airflow 110 through the compressor housing 106 and into the intake manifold of the internal combustion engine.

With continued reference to the embodiment illustrated in FIGS. 6 and 7, outer edges 159, 160 of the blades 142, 152 on the compressor wheel 107 and the exhaust turbine wheel 102, respectively, are rounded or filleted. Additionally, in the illustrated embodiments, circumferential outer edges 161, 162 of the bases 138, 150 of the compressor wheel 107 and the exhaust turbine wheel 102 are rounded or filleted. The rounded edges 159, 160, 161, 162 are configured to reduce the aerodynamic drag induced on the exhaust turbine wheel 102 and the compressor wheel 107 by the exhaust airflow 103 and the ambient airflow 110 through the turbine housing 101 and the compressor housing 106, respectively (i.e., the elimination of sharp edges reduces the drag on the exhaust turbine wheel 102 and the compressor wheel 107). The reduced drag on the exhaust turbine wheel 102 and the compressor wheel 107 allows the exhaust turbine wheel 102 and the compressor wheel 107 to spin faster, which increases the flow rate of the compressed airflow 112 out of the air outlet 111 of the compressor housing 106 and into the combustion chambers of the engine. Accordingly, eliminating the sharp edges on the turbine wheel 102 and the compressor wheel 107 increases the efficiency of the turbocharger assembly 100 and the power output of the internal combustion engine. In one or more alternate embodiments, the exhaust turbine wheel 102 and the compressor wheel 107 may have any other features for breaking the sharp edges of the blades 142, 152 and the bases 138, 150, such as, for instance, chamfers.

With continued reference to the embodiment illustrated in FIGS. 6 and 7, the compressor wheel 107 and the turbine wheel 102 may each be coated with a thermal barrier coating. The thermal barrier coating is configured to reduce heat transfer from the exhaust turbine housing 101 and the turbine wheel 102 to the compressor housing 106, the compressor wheel 107, and the intake air 110 flowing through the compressor housing 106. As described above, reducing heat transfer to the compressor housing 106 increases the density of the intake air 110 and thereby increases the efficiency of the turbocharger assembly 100. The thermal barrier coatings may be applied to any desired surfaces of the compressor wheel 107 and the turbine wheel 102, such as, for instance, the blades 142, 152, the bases 138, 150, the hubs 139, 151, and/or portions thereof. The thermal barrier coatings may be made out of any suitable material, such as, for instance, an aluminum-filled ceramic coating (e.g., Tech Line's CBX, CBX-2, or TLHB Hi Heating Coating) or equivalents thereof.

The compressor housing 106, compressor wheel 107, exhaust turbine housing 101, and the turbine wheel 102 may be formed by any suitable process, such as, for instance, casting, machining (e.g., milling), additive manufacturing, or combinations thereof. Additionally, the compressor housing 106, compressor wheel 107, exhaust turbine housing 101, and the turbine wheel 102 may be made out of any suitable material, such as, for instance, metal (e.g., aluminum or steel), metal alloy, composite (e.g., carbon fiber reinforced plastic), or combinations thereof.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Although relative terms such as “outer,” “inner,” “upper,” “lower,” “below,” “above,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially” and similar terms are used as terms of approximation and not as terms of degree, and are intended to account for the inherent deviations in measured or calculated values that would be recognized by those of ordinary skill in the art. Furthermore, as used herein, when a component is referred to as being “on” another component, it can be directly on the other component or components may also be present therebetween. Moreover, when a component is component is referred to as being “coupled” to another component, it can be directly attached to the other component or intervening components may be present therebetween. Moreover, although the embodiments described above are directed to turbocharger modifications, one or more of the modifications to the compressor of the turbocharger (e.g., protrusions and/or depressions, thermal barrier coatings, tapered air inlets and/or outlets, and grooves) may also be applied to a supercharger or other types of air pressure boosters for internal combustion engines. Additionally, the turbochargers of the present disclosure may be applied to any suitable type of internal combustion engines, such as, for instance, two- or four-cycle spark ignition engines or two- or four-cycle compression ignition engines.

What is claimed is:

1. A turbocharger assembly, comprising:
a turbine housing defining an exhaust inlet opening and an exhaust outlet opening;
a turbine wheel housed in the turbine housing;
a compressor housing defining an air inlet opening and an air outlet opening;
a compressor wheel housed in the compressor housing; and
a shaft coupling the turbine wheel to the compressor wheel,
wherein at least one of the turbine housing, the turbine wheel, the compressor housing, and the compressor wheel includes a surface comprising a plurality of protrusions or depressions.

2. The turbocharger assembly of claim 1, wherein a shape of the protrusions or depressions is selected from the group of shapes consisting of semi-spheres, prisms, pyramids, and cones.

3. The turbocharger assembly of claim 1, wherein a width of the protrusions or depressions is from approximately 1.5 mm to approximately 9.5 mm.

4. The turbocharger assembly of claim 1, wherein a height or depth of the protrusions or depressions is from approximately 0.5 mm to approximately 6.5 mm.

5. The turbocharger assembly of claim 1, wherein the compressor wheel comprises:
a plurality of blades each having a leading edge and a trailing edge; and
a plurality of protrusions or depressions proximate the leading edges of the blades.

6. The turbocharger assembly of claim 1, further comprising a thermal barrier coating on at least one of the turbine housing, the turbine wheel, the compressor housing, and the compressor wheel.

7. The turbocharger assembly of claim 6, wherein the thermal barrier coating comprises an aluminum-filled ceramic.

8. The turbocharger assembly of claim 1, further comprising a plurality of axial grooves circumferentially disposed around an inner surface of at least one of the air inlet opening, the air outlet opening, the exhaust inlet opening, and the exhaust outlet opening.

9. The turbocharger assembly of claim 1, further comprising a plurality of helical grooves disposed around an inner surface of at least one of the air inlet opening, the air outlet opening, the exhaust inlet opening, and the exhaust outlet opening.

10. The turbocharger assembly of claim 9, wherein the helical grooves are spaced apart by approximately 2.5 mm to approximately 12 mm.

11. The turbocharger assembly of claim 9, wherein the helical grooves are angled from approximately 15 degrees to approximately 60 degrees relative to an axis of the inner surface.

12. The turbocharger assembly of claim 9, wherein the plurality of protrusions or depressions are provided within the helical grooves.

13. The turbocharger assembly of claim 9, wherein the plurality of protrusions or depressions are not provided within the helical grooves.

14. The turbocharger assembly of claim 1, wherein the air inlet opening of the compressor housing tapers between a wider outer end and a narrower inner end.

15. The turbocharger assembly of claim 1, wherein the exhaust inlet opening of the turbine housing tapers between a wider outer end and a narrower inner end.

16. The turbocharger assembly of claim 1, wherein the turbine wheel comprises a plurality of blades having rounded edges.

17. A compressor assembly, comprising:
a compressor housing defining an air inlet opening and an air outlet opening;
a compressor wheel housed in the turbine; and
a shaft coupled to the compressor wheel,
wherein at least one of the compressor housing and the compressor wheel includes a surface comprising a plurality of protrusions or depressions.

18. The compressor assembly of claim 17, wherein a shape of the protrusions or depressions is selected from the group of shapes consisting of semi-spheres, prisms, pyramids, and cones.

19. The compressor assembly of claim 17, further comprising a plurality of grooves disposed around an inner surface of at least one of the air inlet opening and the air outlet opening.

20. A turbocharger assembly, comprising:
a turbine housing defining an exhaust inlet opening and an exhaust outlet opening, the exhaust openings each including a surface comprising a plurality of protrusions or depressions and a plurality of grooves;
a turbine wheel housed in the turbine housing including a surface comprising a plurality of protrusions or depressions;
a compressor housing defining an air inlet opening and an air outlet opening, the openings each including a surface comprising a plurality of protrusions or depressions and a plurality of grooves;
a compressor wheel housed in the compressor housing including a surface comprising a plurality of protrusions or depressions; and
a shaft coupling the turbine wheel to the compressor wheel.

21. The turbocharger assembly of claim 20, wherein a shape of the protrusions or depressions is selected from the group of shapes consisting of semi-spheres, prisms, pyramids, and cones.

22. The turbocharger assembly of claim 20, wherein at least one of the exhaust inlet opening, the exhaust outlet opening, the air inlet opening, and the air outlet opening tapers between a wider outer end and a narrower inner end.
